(19) United States
(12) Patent Application Publication
(10) Pub. No.: US 2010/0042420 A1
(43) Pub. Date: Feb. 18, 2010

(54) ENVIRONMENTAL RESOURCE MANAGEMENT SYSTEM AND METHOD

(76) Inventor: Douglas C. Hutchinson, Boynton Beach, FL (US)

Correspondence Address: Douglas C. Hutchinson, 9480 South Military Trail, #4D, Boynton Beach, FL, 33436, US

(21) Appl. No.: 12/192,726

(22) Filed: Aug. 15, 2008

(51) Int. Cl. G06Q 10/00

(52) U.S. Cl. 705/1

(57) ABSTRACT

A method for managing resource usage in an area for members of the area includes the steps of a) determining the initial resource status of the area; b) creating modification standards for the area which have environmentally beneficial attributes; c)—monitoring the execution of modifications to the area by members of the area for conformity to the modification standards; d) managing the performance of the modifications to sustain the environmental attributes of the modifications; and, e) verifying tradable resource units from steps a)-d). A method for managing resource usage in an area includes the steps of monitoring resource transfers into and out of the area; monitoring resource transfers to and from individual-members in the area; determining area resource transfers; determining resource transfers of the individual members; and, determining payment balances of the individual members based upon the resource transfers of the individual members and the resource transfers of the area. The step of determining the resource transfers of the area can include an accounting of resource units created through the process of steps a)-e) above.

### BACKGROUND OF THE INVENTION

There is an increasing need for the global management of environmental resources. Such resources include, without limitation, flora and fauna eco-systems, water, soils, air, noise and energy. Traditionally, such management efforts have focused on conservation of resources and the impact that such conservation efforts have on communities and larger geographical areas and political entities. Efforts to foster conservation have recently begun to be directed to the markets, through the creation of tradable credits that will enable resource users and resource producers to create resource conservation credits that can be bought and sold by private parties or traded on public markets. Such credits create a financial incentive to conserve resources, by providing remuneration for such efforts. There is a continuing and growing need, however, for systems and methods which encourage better resource utilization in a community or other geographic area.

### SUMMARY OF THE INVENTION

A method for managing resource usage in an area for members of the area includes the steps of a) determining the initial resource status of the area; b) creating modification standards for the area which have environmentally beneficial attributes; c)—monitoring the execution of modifications to the area by members of the area for conformity to the modification standards; d) managing the performance of the modifications to sustain the environmental attributes of the modifications; and, e) verifying tradable resource units from steps a)-d).

A method for managing resource usage in an area includes the steps of monitoring resource transfers into and out of the area; monitoring resource transfers to and from individual members in the area; determining area resource transfers of the individual members; and, determining payment balances of the individual members based upon the resource transfers of the individual members and the resource transfers of the area. The step of determining the resource transfers of the area can include an accounting of resource units created through the process of steps a)-e) above.

A system for managing resource usage in an area includes at least one monitoring device for monitoring resource transfers into and out of the area. At least one monitoring device is provided for monitoring resource transfers to and from individual members in the area. At least one device is provided for gathering data from the monitoring resource transfers of the area. At least one device is provided for gathering data from the monitoring of resource transfers of individual members. At least one device is provided for processing payment balances of the individual members based upon the area resource transfers data and the individuals resource transfers data.

### BRIEF DESCRIPTION OF THE DRAWINGS

There is shown in the drawings embodiments which are presently preferred, it being understood, however, that the invention can be embodied in other forms without departing from the spirit or essential attributes thereof.

FIG. 1 is a flow diagram of a method for managing environmental resources according to the invention.

FIG. 2 is a flow diagram of a method for managing environmental resources according to another aspect of the invention.

FIG. 3 is a schematic diagram of a system for managing environmental resources according to the invention.

### DETAILED DESCRIPTION OF THE INVENTION

A method for managing resource usage in an area for members of the area includes the steps of a) determining the initial resource status of the area; b) creating modification standards for the area which have environmentally beneficial attributes; c)—monitoring the execution of modifications to the area by members of the area for conformity to the modification standards; d) managing the performance of the modifications to sustain the environmental attributes of the modifications; and, e) verifying tradable resource units from steps a)-d). Payment balances of individual members are determined based upon the sale of resource units and the performance of the individual members in at least one of steps a)-e).

A method for managing resource usage in an area includes the step of performing a resource audit to determine an initial resource status of the area. Design and construction standards for modifying the area so as to conserve resources, reduce environmental impacts and/or create sustainable systems are created. Verification of the construction, design, and performance of the modifications is performed. Tradable resource units are created based upon the initial resource status assessment, creation of modification standards, monitoring, managing, and verification steps. Monitoring of the modifications to verify sustainability of the resource units is performed. Audits based upon the monitoring step are used to verify or amend the resource units, or to enforce compliance with the terms of the resource units. The method can be performed on a plurality of modifications within an area. An area authority can be created to administer the steps within the area.

The method can further comprise monitoring resource transfers into and out of the area; monitoring resource transfers to and from individual members in the area; determining resource transfers of the area; determining individual resource transfers of the individual members; and, determining payment balances of the individual members based upon the resource transfers of the individual members and the resource transfers of the area. The step of determining the resource transfers of the area can include an accounting of resource units created through the process of steps a)-e) above. Resources used or created by area members can be bought or sold privately or traded on public markets to third parties by the area authority, and area members can be credited or charged according to predetermined criteria such as usage. The method creates incentives for members within the area to work individually and as a community to use and manage resources more effectively and efficiently.

The resources which can be managed according to the invention are broadly defined herein, without limitation, to potentially include any and all natural resources such as, but not limited to, flora and fauna eco-systems, water, soils, air, and energy. Resources can also include man-made or processed resources such as solar energy, biomass fuels production, energy from incineration, and wind, hydro, tide, and thermal energy generation. Resources can also refer to landfill space, solid, semi-solid, liquid, or gaseous waste, recyclable materials, and biomass. Resources can also refer to water and wastewater streams such as rain water, gray water, and black water. Resources can also include noise or, more particularly, the absence of man-made noise.

Resources can also include other kinds of man-made concepts which exist now or may be created in the future to foster conservation or otherwise reduce adverse environmental impacts, for example and without limitation carbon credits, waste disposal credits, emission credits for various pollutants, and water credits. Credits can refer to any kind of resource credits, whether created and defined by or between private parties, standards organizations, governmental authorities, or the like. It is necessary that the credits be identified, quantified, and verified so that these credits can be used to create tradable resource units. Procedures to identify, quantify, and verify credits are available or can be created for carbon credits, water credits, waste disposal credits, and renewable energy credits. These credits may take various forms. Carbon credits, for example, can take the form of certified emission reductions (CERs) and voluntary emission reductions (VERs) which, among other things, can award credits of one form or another for the removal, limitation, reduction, avoidance, sequestration or mitigation of greenhouse gases (GHG). There are in existence today several different recognized standards for issuing carbon credits. These include the Gold Standard (www.cdmgoldstandard.org), the Voluntary Carbon Standard (www.v-c-s.org), the Voluntary Offset Standard (www.carboninvestors.org), the VER standard (www.tuev-sued.com), the Climate Community and Biodiversity standard (www.climate-standards.org), the Green-e standard (www.green-e.org), and the California Climate Action Registry standard (www.climateregistry.org). The invention can be used with all such types of standards, as well as other standards which may be created in the future.

The term credit is used in the broadest sense to also include debits. Modifications that are not environmentally desirable or less than or not in conformity with modification standards can result in credits which are negative, or debits. Debits might be issued, for example, where a member performs modifications according to designs that do not comport with area standards, or where the member engages in resource usage that is substandard for the area, or where the resource usage of the member exceeds that for that member in the past, or for particular goals and standards set for the member or for the area. Substandard or undesirable behavior will cost the member credits which must be obtained elsewhere or paid for in cash in some other fashion.

Tradable resource units refers to the various means by which resource usage and conservation and environmental impacts can be considered for the purpose of creating a financial instrument which is capable of being bought and sold, either through a private transaction or through public markets. Resource units can be defined and quantified in terms of simple volumes or weights and measures, such as gallons of water and kilowatts of energy, or in more abstract and defined terms such as carbon credits or other types of credits. A plurality of resources or credits can be bundled to create a tradable resource unit, much in the same way that commodities are traded in units comprised of fixed-amounts of the commodity. In the case of public markets, tradable resource units will be defined by the rules of the various exchanges, such as commodity exchanges, which provide for trading of such resource units, or by the rules of various agencies or authorities which may be adopted by such exchanges for purposes of trading. In the case of private transactions, the tradable resource units can refer to any units defined or adopted by the participants to the transaction. Tradable resource units could also be defined in the future by legislation or by rules promulgated by governmental authorities such as the United States Securities and Exchange Commission or the United States Environmental Protection Agency, or appropriate state agencies.

The area authority can be responsible for the creation and trading of tradable resource units for the area. This requires the gathering of information and the presentation of proofs that are required by the governing body issuing the resource units, and verification of the sustainability of the resource units over the required duration of those units. In the case of carbon credits, for example, the duration of tradable carbon credits is currently between 10-15 years, depending on the issuer of the credit. The area authority must verify that the tradable resource unit will remain valid and that the conditions of the units, and of any resource credits making up the resource units, are being met.

The area authority can act as an interface or intermediary for members of the area with utilities, resource suppliers, and other resource users or consumers outside the area. The area authority on behalf of its members can, for example, buy power for the area or sell power if the area is a net generator of power. As the area authority acts on behalf of many members, the area authority can negotiate pricing for the area more effectively than could individual members negotiate themselves, and can have centralized resource storage, such that resources such as power can be purchased in non-peak periods, when power costs are reduced, and store this power in battery facilities until it is needed by the members. Similarly, the area authority can buy water in an appropriate season when water supplies are more plentiful and costs are reduced, and store this water in area water storage facilities until it is needed by area members.

Area conservation efforts that result in net generation of resources can be accumulated and sold by the area authority to outside purchasers or suppliers of resources, such as utilities, on behalf of area members. For example, standard water usage may be set by a water utility or governmental authority at 250 gallons/month per member (tap). The area members must pay facility fees for that amount. But if the design standards of the area result in average usage of only 100 gallons per member (tap), the area authority can negotiate on behalf of its members for a water credit of 150 gallons/month per member. Savings or rebates of the facility fees that are paid to government agencies can thereby be obtained for the benefit of the members. Similarly, power, water and other resources that are net-generated by area members can be sold by the area authority to external purchasers. The area authority may choose to store such generated resources for sale to third parties during periods when prices are highest. In the case of power, this could be during peak usage periods. In the case of water, this could be during the dry season when supply is low. In other instances, for example, a community might plant trees, providing more trees than existed before on the site. The increase in the number of trees can generate carbon credits for the community which can be packaged and sold by the area authority to purchasers of these credits outside of the area.

The area authority administers to and accounts for resource usage (or generation) within the area, and buys resources from and sells resources to third parties outside of the area based upon this usage or generation within the area. A member who generates net resources can be paid by the area authority for that member's generation efforts. A member who uses net resources must pay the area authority, who pays suppliers from outside the area for those resources, or pays members from inside the area who are net generators of the resource. The area authority accounts for these transfers of resources, and administers payments both to and from area members. The area authority also creates and sells tradable resource units from the resources, including credits, which can be generated or saved by its members, and distributes the proceeds of such sales to the members on an annual or other suitable basis.

The area authority can be the entity that deals directly with area members to supply resources, and not an outside utility. Individual members buy resources from and sell resources to the area authority. The area authority buys any necessary resources from outside utility companies or other outside suppliers of the necessary resources. Resources can enter the area through a central receiving station or are accounted for by meters or other means so that the area authority is informed of all resource transfers into and out of the area. Distribution of resources within the area can thereby be monitored and controlled by the area authority. The area authority monitors and controls resource distribution, storage and generation within the area. If a member generates a resource, it can be sold by the area authority to another member in the area, possibly at a discounted rate, or to a purchaser outside the area such as a utility. The area authority thereby also acts as a kind of bank, buying and selling resources, banking resource units, and making and receiving payments from members, all for the benefit of the members of the area.

The area authority assists the members by accumulating sufficient resource generations by its members to create a tradable resource unit. Small resource generation efforts by individual members are not sufficiently large to be tradable on public markets. Individual efforts, such as the planting of trees or native landscaping requiring less watering, or the installation of a new solar array, must be accumulated to be tradable. The area authority has the expertise to create grouped applications for resource units on behalf of all of the members, and can do so efficiently. Tradable resource units such as carbon credits are currently of 10-15 year duration. The area authority must verify, such as by submitting proofs, that the credits will have the desired duration in order to gain approval of the credits. Many purchasers of resource units will want resource units for the full term or duration of the units or of credits comprising the units, although the time period could be for a lesser or greater defined period of time. The area authority can administer such sales on behalf of all of the members. The area authority creates a bank of resource units, such as for carbon credits, starting at the baseline derived from the initial assessment and the development/construction process. The area authority also monitors and audits existing resource units, such as for carbon credits, to be sure they are still valid.

The area authority also can own resources, such as credits created by improvements to the area in common areas not owned by an individual member. Such credits could be derived from the use of environmentally beneficial road materials such as fly ash, the creation of environmentally favorable water and sewage treatment systems, the installation of area energy generation systems, and the like. These credits can be used by the area authority to generate tradable resource units that are held for the benefit of the members, and can be distributed or apportioned to the members by any suitable basis, guidelines, or formulas, such as per capita, per square foot of area owned by the member, or by some environmental performance criteria. The members of the area can thereby be provided with monetary incentives for their individual and collective conservation efforts.

The area authority must also make up for any shortfall or account for any surplus required by any tradable resource unit contract or private contract with a third party for resource units. Resource units are dynamic and will change, so the area authority will usually only pledge a range of units such as carbon credits, such as X±n, rather than a fixed number such as X, so as to avoid penalties for going below the pledged amount or having to buy credits to make up the difference if a shortfall exists. The area authority monitors changes to the resource usage in the area and can if appropriate apply for more tradable resource units.

The area authority can be any suitable organization, whether governmental, quasi-governmental, or private which administers the initial resource status determination, design and construction standards, verification and trading steps. The area authority can be a single entity or can be comprised of several entities, or by divisions, affiliates or agents of such entities. The area authority can perform only the duties required by the invention, or can perform many functions for the area in addition to addressing environmental concerns. For example, the area authority can be part of a property owners association (POA) or a community co-operative (CO-OP). Other area authorities are possible. For example, the area authority can provide stewardship in terms of auditing construction and going forward status of resource utilization and operation of conservation installations. The area authority verifies, monitors, and manages to insure compliance and that tradable resource units created and sold remain verifiable. The area authority may have some enforcement capability, whether through fines, assessments, and the like, to bring about compliance or to pay for non-compliance.

The method of the invention can be used to manage development impacts on resources from initial area status through completion of the project and ongoing use. Accordingly, in one embodiment, the initial environmental status of the area is determined. This is accomplished by environmental studies and other assessment methods which examine environmental attributes such as, without limitation, soil quality and composition, water quantity and quality, resource contamination if any, air quality of the site, flora and fauna such as trees for lumber, and the like. Environmental assessment methods are known, and any such methods are suitable. Such techniques can include methods for determining environmental changes to the initial status for purposes of awarding credits. The initial status can be determined for both undeveloped (greenfield) and previously developed (brownfield) sites. In a populated area, the initial status may include an assessment of existing improvements on the land, such as buildings, roads, landscaping and the like, to assess the credits to be awarded (or required) for changes that are made to the area. The initial status is recorded for purposes of comparing the initial status to the status during the construction/modification process and at the completion of the process, to assess the credits to be awarded (or required) for modifications that are made to the area. The initial status of an area is determined with respect to both qualitative and quantitative factors. The initial status must be known in order to determine impacts of modifications to the area or to a specific site within the area.

The determination of the initial resource status can also include an assessment of the availability, cost, and environmental attributes of resources which must be imported into the area. For example, an area which must import water from a distant reservoir has fewer environmental resources than an area which is adjacent to a desalinization plant with existing capacity to serve the area. An area which must import electricity but is adjacent a solar electrical generation facility has more environmental resources than an area which must draw power from a system that is already overburdened, or that generates that electricity from a less environmentally beneficial method of generation, such as combustion.

Design, construction and development standards are created for modifications to the area which are designed to provide environmentally beneficial attributes, such as to conserve resources, reduce environmental impacts, and create tradable resource units. The modification standards can set forth a matrix for the area which values not only the physical space of the member's home or building, but also its environmental impact. The modification standards can include the designation of portions of the area which are to be left alone in the natural state, or otherwise are to remain unmodified. The area authority, POA, or CO-OP can develop, review, and if necessary approve, design standards and plans for construction/development to insure best environmental practices. Any or all of these duties can be delegated or contracted to third parties, under the direction and control of the area authority.

The execution of modifications to the area is monitored to determine conformity to the modification standards. The area authority can perform this function, although others can alternatively monitor the modifications. The monitoring function is essentially one of inspection and possibly testing of the modifications to determine whether the modifications have been made according to the design standards. Any suitable inspection or testing methods or equipment can be utilized, depending on the nature of the modifications that are being monitored.

The performance of the modifications is managed to sustain the environmental attributes of the modifications. Modifications can be subject to degradation or breakage. Water treatment systems can foul, solar panels can break, pollution abatement systems can sometimes no longer be effective. Resource usage by members that was once at one level can over time change to another level. The performance of the modifications must therefore be managed to determine whether the environmental attributes of the modifications are sustained over time. This can be performed by inspection and in some cases testing. The area authority can perform the management function, or this function can be assigned or delegated to another entity. Any suitable method or equipment for managing the performance of the modifications can be utilized. The inspection and testing can be performed at regular time intervals, or at such times as the area authority or other management entity deems appropriate.

Verification is performed to insure that the determination of initial resource status, creation of modification standards for the area which have environmentally beneficial attributes, monitoring the execution of the modifications to the area by the members of the area for conformity to the standards, and managing the performance of the modifications to sustain the environmental attributes of the modifications, are performed in accordance with the rules and regulations of entities issuing tradable resource units. In this manner, the area authority can apply for and maintain tradable resource units on behalf of the members, which ultimately will benefit the members.

Each area member will have an imaginary resource footprint in an area matrix that will depend on both square footage of the member's property and/or structure and environmental attributes that are design driven such as the existence of solar power generation or solar water heating equipment that is possessed by the member, improved insulation, water or power saving interior fixtures, and the like. A matrix of square footage and environmental attributes allows the area authority to assess the environmental impact of each member of the area, be that impact positive or negative as regards a particular resource. The member will thereby be able to aggregate credits based upon the design features that the member selects and installs in the member's home or building. These credits are used by the area authority to create tradable resource units, which are credited back to the member by some suitable distribution method or criteria. The area authority serves as a kind of bank for the members of the area, accumulating resources such as resource credits of the various members, creating tradable resource units from the resources, and holding the tradable resource units and distributing or otherwise crediting them to the members of the area. An incentive is thereby created for the member to use environmentally beneficial designs, equipment, and methods.

The area authority also serves as a kind of resource broker, buying and selling resources from members based upon usage, and then buying and selling those resources to third parties outside of the area or other members within the area. The third parties can include, without limitation, water and power utilities, waste disposal utilities and companies, outside brokers for a resource, or any other purchaser or seller of a resource. Excess surplus or demand for resources is credited or debited by the area authority to members according to individual usage of those resources by the members. An incentive is thereby created for the members to use fewer resources, or even to generate resources.

It is increasingly a concern that construction materials and methods be devised and used that do not adversely affect the environment, or are less damaging to the environment. A construction project that results in a favorable environmental facility but which nonetheless is made using construction techniques which are not environmentally favorable is less desirable than a project that is constructed with environmentally favorable methods and equipment. For example, a construction site that operates equipment and trucks using biofuels, and that recycles construction waste, has less adverse environmental impacts than a site which does not. The Leadership in Energy and Environmental Design (LEED) program administered by the US Green Building Council provides construction standards which reduce the impact of new construction on the environment. Such standards and newly developed standards can be considered as a factor in the award of credits for modifications to an area.

The manner in which the resource transfers into and out of the area, and to and from individual members in the area, are monitored can vary. In the case of energy resources, meters and measures of various kinds can be used. In the case of water or waste credits, these too can be readily quantified. In the case of flora and fauna, these can be measured by categorizing the same according to quantity and quality, where quality can refer to various factors such as species, size, age, and health. Resource credits are monitored according to the criteria that are used to define the credits. For example, carbon credit standards often define the performance criteria that are required to retain the credit. The monitoring of resource transfers of the individual members is used to encourage individual members in the area to engage in more environmentally favorable actions. Individual members are required to purchase excess resources from the area authority, and can sell excess resources to the area authority. It is necessary that the methods of assessing costs to the resources be reasonably constructed so as to be perceived as fair and understandable to the members, and thus to encourage environmentally favorable resource usage and behavior.

The manner of crediting or charging individual members for their respective resource transfers can vary. In general this will be accomplished by an overall consideration of the resource usages of the area. In the case of a community, for example, water and energy usage of the community can be readily measured and quantified. In some cases, a community may have power generation capability which exceeds the needs of the community. In such cases, the community will return energy to the grid that services the community. This will provide a source of income or revenue for the community. The area authority will distribute this revenue to the members by a suitable methodology, which can include the relative resource contributions of each member to the area.

The invention assesses resources and resource transfers based upon a matrix which considers not only quantitative factors of the resources, but also qualitative factors. That is, the quality of the resource can be as important as the quantity of the resource when determining credits. For example, in the case of planting or removing trees, the type, age and size of the tree, as well as other suitable factors, can be considered. Solid waste cannot only be quantitatively measured, but also qualitatively measured. The amount or percentage of the waste that is recyclable can be a measure of its quality. The amount of waste that is considered toxic to one degree or another can be a quality measure. The amount of waste that is biodegradable can also be a quality factor. These factors can be used with quantity to determine the total credits that are issued to the member. Similarly, water resources can be determined based upon both quality and quantity. In the case of a manufacturer member, for example, the amount of water that is used is considered with the quality and quantity of the water that is returned by the manufacturer to the system or to the area. For example, if the water is returned substantially in the condition it was received by the manufacturer, this will have more favorable environmental impacts than if the water is returned with contaminants which require processing.

The environmental impacts caused by the generation of a resource such as energy must be considered along with the quantity of energy that is produced. For example, it is not as helpful to the environment that an area generates a positive energy flow if that energy is created by incineration or coal fired plants that adversely affect the environment. Similarly, although wind or solar generation technologies might produce a smaller quantity of energy, the more favorable environmental impacts of such technologies compared to coal-fired technologies must be considered along with the kilowatts that are produced by each technology. An area may generate trash but if aluminum is present and is recycled and separated for processing, this will provide positive impacts that must be taken into account. Gray water is not potable but is usable for irrigation. Black water is water that has to be heavily processed, or contains fecal matter, urine, and/or other contaminants. More resource credits, or in this case debits, would be issued for water that is returned to the system with more contaminants, with the number of credits (debits) depending on the type and quantity of contaminants that are added to the water by the manufacturer. The manufacturer is thereby provided with an incentive to install clean water processes or scrubbing processes to clean the water prior to release.

Sustainability of the environmental attributes generated by the modifications is an important consideration. The performance of the modifications is managed to sustain the environmental attributes of the modifications. Environmental credits must be sustainable if the credits are to retain meaning and value. Some environmental credits such as carbon credits have a term of 10-15 years. The validity of the credit over time must be maintained for the credit to retain value. Processes and systems which provide some short term environmental attributes, but which do not last or which deteriorate with time, must be credited accordingly. Environmental attributes that are fully sustainable over time must be credited more than attributes and processes which are not.

The term area as used herein refers broadly to the scope, or boundaries or limits defining the set of members to which the method and system of the invention will be applied. An area can be a community that is defined by geographical boundaries. An area can alternatively be a set of members which share common attributes, such as manufacturers, power generating stations, farms, or members which have a similar number of employees, or make a similar product or perform a similar service, whether in the same geographical location or not.

The term individual member refers broadly to defined members within the area. An individual member can be a single person but is not so limited. The individual member can be a single household, or a single building or condominium, a single business or manufacturer, a power generation or water treatment or waste disposal facility. Any subset of resource usage within the area can be defined as an individual member. The definition must only be applied throughout the area, the individual member must exist within the area or be included in its definition, and the resource usage of the individual member must be capable of being monitored.

The manner of determining payment balances of the individual members based upon the resource transfers of the area and the resource transfers of the individual members can vary. The payments can be monetary payments or in the form of credits that are banked and can be used by the individual members to offset negative credit balances that the individual members might have elsewhere. Payments can be made to a member where credits are generated by the member, or payments can be received from the member where credits are consumed by the member. Also, resource units may be offered for sale in one or more trading markets, or offered in private transactions for sale or trading.

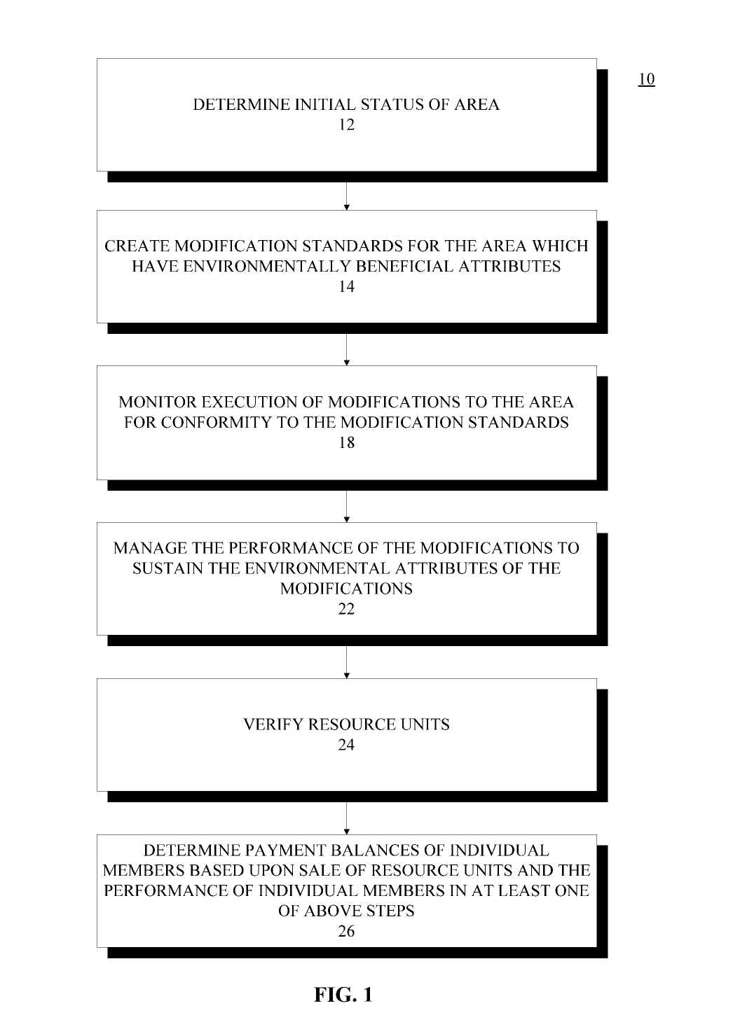

There is shown in FIG. 1 a flow diagram illustrating a method for managing resource usage in an area according to the invention. The method 10 begins in step 12 with determining the initial status of the area. The method 10 continues with the step 14 of creating modification standards for the area which have environmentally beneficial attributes. The execution of modifications to the area by members of the area are monitored for conformity to the modification standards at step 18. The performance of the modifications is managed at step 22 to sustain the environmental attributes of the modifications. Verifying resource units is performed at step 24. Payment balances of individual members are determined at step 26 based upon the sale of resource units and the performance of individual members in at least one of the above steps.

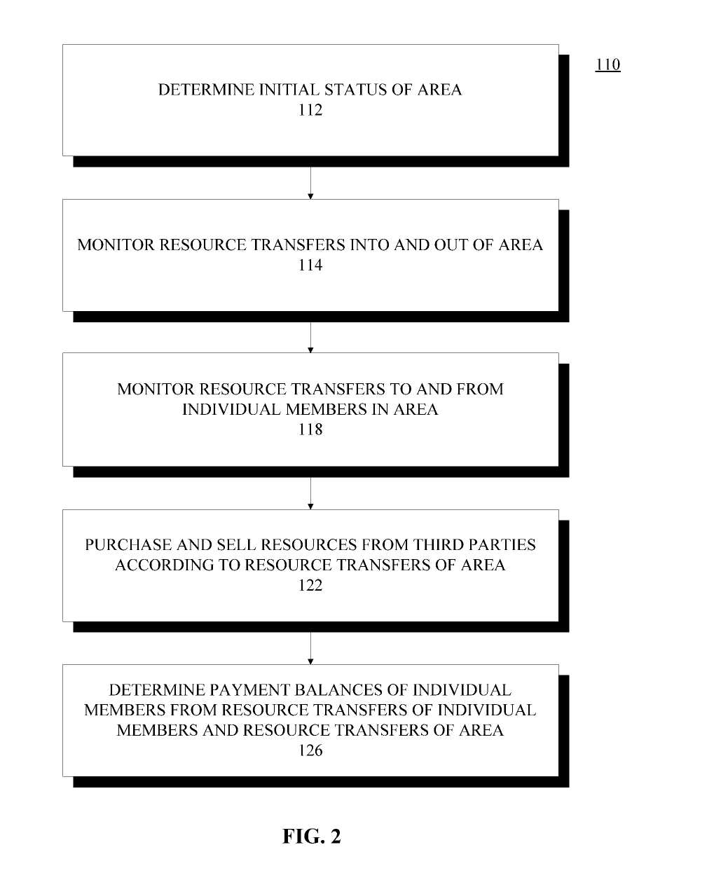

There is shown in FIG. 2 a flow diagram illustrating a method for managing resource usage in an area according to the invention. The method 110 begins in step 112 with determining the initial status of the area. The method 110 continues with the step 114 of monitoring resource transfers into and out of the area. Resource transfers to and from individual members in the area are monitored at step 118. Resources are purchased and sold from third parties according to the resource transfers of the area at step 122. Payment balances of individual members are determined from the resource transfers of individual members and the resource transfers of the area at step 126.

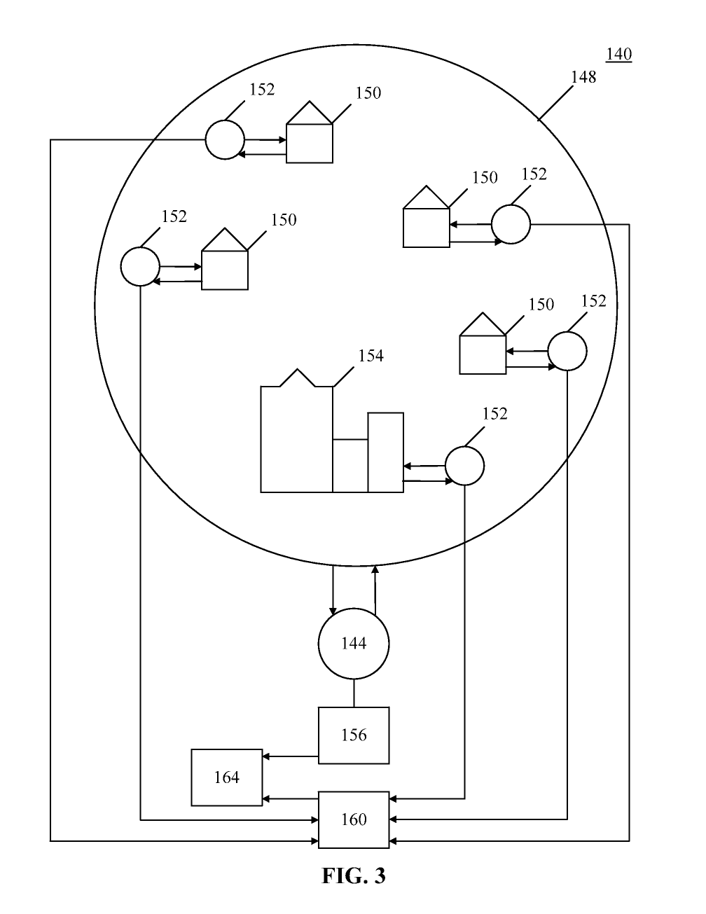

A system for managing resource usage in an area is shown in FIG. 3. The system 140 includes at least one monitoring device 144, for example a meter, for monitoring resource transfers into and out of the area 148. At least one monitoring device 152, for example a meter, is provided for monitoring resource transfers to and from individual members in the area. The individual members can be residences 150, but can also be businesses, factories, or other large entities such as municipal power generation stations or water treatment plants 154. At least one device 156 is provided for gathering data from the monitoring of resource transfers of the area. At least one device 160 is provided for gathering data from the monitoring of the resource transfers of individual members. The device 156 and the device 160 can be separate devices or these functionalities can be combined in a single device, such as a computer, computer program, or a computer database. At least one device 164, such as a computer or computer program, is provided for processing payment balances of the individual members based upon the resource transfers of the area and the resource transfers of the individual members. The system 140 can be used to monitor resource usage and generation by members and to allow the area authority to buy and sell resources on behalf of all of the members in the area. Members generating resources such as power can sell these resources to other members through the area authority, without selling and buying through an outside utility, lowering transaction costs.

Monitoring systems are provided to define, track and analyze on-going environmental and man-made resource use, sustainability, conservation, and preservation through the area's development and thereafter on-going use. The system establishes and monitors a set standard(s) for use, sustainability, preservation and conservation of the area's resources in a matrix format identifying the resource, its condition and any change. The matrix of qualitative and quantitative factors will be used to encourage behavior which exceeds minimum standards and penalizes sub-standard resource stewardship. The matrix and monitoring process allows constant, uniform and ever-improving management of resources over both short and long periods of time. The matrix system monitors resources within a prescribed format so as to qualify the area for third party market sales and/or trade of resources or resource credits.

This invention can be embodied in other forms without departing from the spirit or essential attributes thereof and, accordingly, reference should be had to the following claims rather than the foregoing specification as indicating the scope of the invention.

We claim:

1. A method for managing resource usage in an area for members of the area, comprising the steps of:
a) determining the initial resource status of the area;
b) creating modification standards for the area which have environmentally beneficial attributes;
c) monitoring the execution of modifications to the area by members of the area for conformity to said modification standards;
d) managing the performance of the modifications to sustain the environmental attributes of the modifications; and,
e) verifying tradable resource units from steps a)-d).

2. The method of claim 1, wherein said step of determining said initial resource status comprises the assessment of air, soil, water, flora and fauna of area.

3. The method of claim 1, wherein said step of determining said initial resource status comprises assessment of existing improvements in said area.

4. The method of claim 1, wherein said step of determining modifications comprises developing guidelines for said modifications.

5. The method of claim 4, wherein said managing step comprises comparing said modifications to said guidelines.

6. The method of claim 1, wherein said monitoring step comprises performing testing to determine the environmental attributes of said modifications.

7. The method of claim 1, wherein said verifying step comprises the creation of records of said monitoring steps.

8. The method of claim 1, wherein said verification includes quantifying said environmentally beneficial attributes.

9. The method of claim 1, wherein said modifications are environmentally beneficial relative to the initial resource status of the area.

10. The method of claim 1, wherein said verification step comprises the creation of tradable resource units.

11. The method of claim 1, further comprising the step of creating an area authority to perform at least one of said determining the initial resource status of the area, creating modification standards for the area which have environmentally beneficial attributes, monitoring the execution of the modifications by members of the area, managing the performance of the modifications to sustain the environmental attributes of the modifications, and verifying the tradable resource units steps.

12. The method of claim 11, wherein the area authority buys and sells resources from and to the members, and buys and sells resources from and to third parties.

13. The method of claim 1, further comprising the steps of:
monitoring resource transfers into and out of said area;
monitoring resource transfers to and from individual members in said area;
determining area resource transfers;
determining individual resource transfers of said individual members; and,
determining payment balances of said individual members based upon the resource transfers of the individual members and the resource transfers of the area.

14. The method of claim 13, wherein said step of determining the resource transfers of the area can include an accounting of resource units created through the process of steps a)-e).

15. The method of claim 1, wherein said resources comprise at least one selected from the group consisting of flora and fauna eco-systems, water, soils, air, solar energy, biomass fuels production, energy from incineration, and wind, hydro, tide, and thermal energy generation, landfill space, solid, liquid, or gaseous waste, recyclable materials, and biomass, water and waste water streams, and noise.

16. The method of claim 1, wherein resources comprise at least one selected from the group consisting of carbon credits, waste disposal credits, pollutant emission credits, and water credits.

17. The method of claim 1, wherein said environmentally beneficial attributes comprise at least one of resource conservation and resource generation relative to initial area status.

18. A method for managing resource usage in an area, comprising the steps of:
monitoring resource transfers into and out of said area;
monitoring resource transfers to and from individual members in said area;
determining resource transfers of said area;
determining resource transfers of said individual members; and,
determining payment balances of said individual members based upon the resource transfers of the individual members and the resource transfers of the area.

19. A system for managing resource usage in a community, comprising:
at least one monitoring device for monitoring resource transfers into and out of said area;
at least one monitoring device for monitoring resource transfers to and from individual members in said area;
at least one device for gathering data from the monitoring of resource transfers of said area and for gathering data from the monitoring of resource transfers of said individual members; and,
at least one device for determining payment balances of said individual members based upon the resource transfers of the individual members and the resource transfers of the area.
